(19) United States
(12) Patent Application Publication
(10) Pub. No.: US 2021/0317997 A1
(43) Pub. Date: Oct. 14, 2021

(54) HYDRONIC SPACE CONDITIONING AND WATER HEATING SYSTEMS WITH INTEGRATED DISINFECTING DEVICE

(71) Applicant: HARVEST THERMAL, INC., Kensington, CA (US)

(72) Inventor: Evan GREEN, Escondido, CA (US)

(21) Appl. No.: 17/226,804

(22) Filed: Apr. 9, 2021

Related U.S. Application Data
(60) Provisional application No. 63/008,645, filed on Apr. 10, 2020.

(51) Int. Cl. F24D 17/00; F24D 3/08; G05D 23/01; G05D 23/32; F24D 19/10; G06Q 50/06

(52) U.S. Cl. CPC F24D 17/0073; F24D 3/082; G05D 23/01; G05D 23/32; F24D 2220/0221; G06Q 50/06; F24D 2220/0207; F24D 2220/0257; F24D 19/1066

(57) ABSTRACT

Embodiments of the present disclosure provide a system for disinfecting water for hydronic space conditioning and domestic hot water. The system includes a thermal storage tank, a disinfecting device and a control unit. The control unit monitors an outlet temperature of water exiting the thermal storage tank. Further, the control unit calculates a temperature difference between a temperature threshold limit associated with the disinfecting device and the outlet temperature. The control unit transmits a first signal to the disinfecting device when the temperature difference is a positive value. The first signal operates the disinfecting device in the activation mode for heating the water to provide anti-bacterial sanitation. The control unit transmits a second signal to the disinfecting device for deactivating the disinfecting device when the temperature difference is a negative value. The sanitized water from the disinfecting device is used for conditioning an enclosure and a domestic hot water.

### TECHNICAL FIELD

The present disclosure relates to hydronic space conditioning systems and, more particularly to methods and systems for disinfecting water for hydronic space conditioning systems and domestic hot water delivery.

### BACKGROUND

Hydronic systems are typically thermo-fluid dynamic systems that utilize water as a primary fluid to transfer energy (i.e. heating and cooling) for residential, commercial, and/or industrial use. Typically, the hydronic systems employ a heat source (such as boilers) and a cooling source (such as chillers or cooling towers) for conditioning spaces or interiors of a building (e.g., homes, industrial facilities) as per the requirements. Conventional hydronic systems use energy sources obtained by the combustion of natural gas, propane, coal, fuel oil, wood, and other fuels for operating boilers to heat the fluid. The combustion of such fuels results in the emission of greenhouse gases (GHG) and potentially other pollutants.

Alternatively, electricity can be used to operate heat pumps for heating or cooling the fluid or resistive elements for heating the fluid. Generally, the hydronic systems that utilize electricity for generating energy (i.e. heating or cooling) include high-power resistive heating elements or lower-power heat pumps. Such systems face a design tradeoff between up-front and operating costs. That is, resistive heating is capable of providing rapid heat (high power) at typically low equipment costs and heat pumps are capable of providing higher electricity-to-heat conversion efficiency. In a system utilizing hot water storage prior to delivery, a resistive heater will provide more rapid make-up heat capability, and also more flexibility for variable delivery temperature in the event of storage insufficiency. This implies a preference in a high efficiency (i.e. heat pump) system to store water at the maximum possible temperature.

Additionally, water storage and its delivery temperatures for control of bacterial growth are in conflict with protection of the end user from the risk of scalding. This is because water at temperatures sufficient to control bacterial growth is dangerously hot for end usage. Further, cooler water storage would reduce the amount of available stored energy, and also increase the risk of bacterial growth.

As such, the risk of bacterial growth in the stored water can be overcome by ensuring that delivery temperature is sufficiently high to disinfect the water. But, this risk is always present in commonly available hot water delivery systems, and may possibly be increased in a system which stores water at reduced temperature. In this scenario, subjecting the water for disinfection results in increase in temperature of the water. Thus, the temperature of the delivered hot water for residential use is too high and therefore pose a scalding risk. Operating alone, either the low-power resistive or heat pump heating elements may lack the capacity to deliver water with sufficient heat appropriate for conditioning the interiors of the building as per the user's requirement.

Therefore, there is a need for techniques to simultaneously overcome interrelated limitations of element power, storage temperature and system design goals while also reducing bacterial growth risks.

### SUMMARY

Various embodiments of the present disclosure provide methods and systems for disinfecting water for hydronic space conditioning systems and domestic water delivery.

In an embodiment, a system is disclosed. The system includes a thermal storage tank, a disinfecting device operatively coupled to the thermal storage tank, and a control unit operatively coupled to the disinfecting device. The control unit is configured to monitor an outlet temperature of water exiting the thermal storage tank via a first set of temperature sensors mounted to the thermal storage tank. The control unit is configured to calculate a temperature difference between a temperature threshold limit associated with the disinfecting device and the outlet temperature of the water exiting the thermal storage tank. Further, the control unit is configured to operate the disinfecting device selectively, in an activation mode and a deactivation mode based at least on the temperature difference in order to deliver sanitized water for at least conditioning an enclosure and a domestic hot water. The control unit transmits a first signal to the disinfecting device when the temperature difference is determined to be a positive value. The first signal operates the disinfecting device in the activation mode for heating the water from the thermal storage tank to provide anti-bacterial sanitation. Further, the control unit transmits a second signal to the disinfecting device to operate the disinfecting device in the deactivation mode when the temperature difference is determined to be a negative value.

In another embodiment, a method for disinfecting water for hydronic space conditioning and domestic hot water delivery is disclosed. The method performed by the control unit includes monitoring an outlet temperature of water exiting a thermal storage tank via a first set of temperature sensors mounted to the thermal storage tank. The method includes calculating a temperature difference between a temperature threshold limit associated with a disinfecting device and the outlet temperature of the water. Further, the method includes operating the disinfecting device selectively, in an activation mode and a deactivation mode based at least on the temperature difference in order to deliver sanitized water for at least conditioning an enclosure and a domestic hot water. Further, selectively operating the disinfecting device by the control unit includes transmitting a first signal to the disinfecting device when the temperature difference is determined to be a positive value. The first signal operates the disinfecting device in the activation mode for heating the water from the thermal storage tank to provide anti-bacterial sanitation. Further, the method includes transmitting a second signal to the disinfecting device to operate the disinfecting device in the deactivation mode when the temperature difference is determined to be a negative value.

In yet another embodiment, a system for disinfecting water for hydronic space conditioning and domestic hot water delivery is disclosed. The system includes a thermal storage tank, a disinfecting device operatively coupled to the thermal storage tank, and a control unit operatively coupled to the disinfecting device. The control unit is configured to monitor an outlet temperature of water exiting the thermal storage tank via a first set of temperature sensors mounted to the thermal storage tank. The control unit is configured to calculate a temperature difference between a temperature threshold associated with the disinfecting device and the outlet temperature of the water exiting the thermal storage tank. Further, the control unit is configured to operate the disinfecting device selectively, in an activation mode and a deactivation mode based at least on the temperature difference in order to deliver sanitized water for at least conditioning an enclosure and a domestic hot water. The control unit transmits a first signal to the disinfecting device when the temperature difference is determined to be a positive value. The first signal operates the disinfecting device in the activation mode for heating the water from the thermal storage tank to provide anti-bacterial sanitation. Further, the control unit transmits a second signal to the disinfecting device to operate the disinfecting device in the deactivation mode when the temperature difference is determined to be a negative value. The control unit is further configured to monitor a temperature and a flow rate of the sanitized water exiting the disinfecting device via at least one temperature sensor and at least one flow meter respectively, configured in a conduit connecting the disinfecting device and a thermal distributor. The control unit is configured to operate a pump fluidically coupled to the thermal distributor and the disinfecting device for adjusting the flow rate of the sanitized water entering the thermal distributor. The flow rate is adjusted based at least on a target temperature for conditioning the enclosure, and the temperature and the flow rate of the sanitized water exiting the disinfecting device.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 is an example representation of an environment related to at least some example embodiments of the present disclosure;

FIG. 2 is a simplified block diagram representation of a hydronic system, in accordance with an example embodiment of the present disclosure;

FIG. 3 is a simplified block diagram representation of the hydronic system for improving efficacy in conditioning an enclosure, in accordance with an example embodiment of the present disclosure;

FIG. 4 is a simplified block diagram representation of the hydronic system for improving efficacy of hot water delivery to a domestic hot water, in accordance with an example embodiment of the present disclosure;

FIG. 5 is a simplified block diagram representation of the hydronic system depicting a return path for sanitized water, in accordance with an example embodiment of the present disclosure;

FIG. 6 is a block diagram representation of a control unit of the hydronic system of FIG. 2, in accordance with an example embodiment of the present disclosure;

FIG. 7 illustrates a flow diagram of a method for disinfecting water for hydronic space conditioning and domestic hot water delivery, in accordance with an example embodiment of the present disclosure; and

FIG. 8 is a block diagram of a server system capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various embodiments of the present disclosure provide techniques for disinfecting water for hydronic space conditioning and domestic hot water delivery. At least one embodiment of the present disclosure provides a control unit that adapts the operation of one or more components of the hydronic system to manage space conditioning and the domestic hot water delivery at a temperature safe from scalding at a point of use. Herein, the terms ‘space’ or ‘enclosure’, unless the context suggests otherwise, refer to an interior of a building, premises, or any enclosed space which needs to be maintained at intended temperatures.

In an embodiment, the control unit is configured to monitor temperature of hot water within a thermal storage tank via a first temperature sensor mounted to the thermal storage tank. The thermal storage tank may be configured to store water in a stratified manner. Further, the control unit selectively operates a heat pump unit fluidically coupled to the thermal storage tank to generate the hot water for recharging a volume of hot water within the thermal storage tank, when the temperature of the hot water within the thermal storage tank falls below a predefined threshold value. The predefined threshold value corresponds to a temperature that is optimal for operating a disinfecting device between an activation mode and a deactivation mode.

The control unit is further configured to monitor an outlet temperature of the hot water exiting the thermal storage tank via a first set of temperature sensors mounted to the thermal storage tank. The control unit operates the disinfecting device based on the outlet temperature of the hot water exiting the thermal storage tank. In particular, the control unit calculates a temperature difference between a temperature threshold limit associated with the disinfecting device and the outlet temperature of the hot water exiting the thermal storage tank. Thereafter, the control unit operates the disinfecting device selectively, in an activation mode and a deactivation mode based at least on the temperature difference in order to deliver sanitized water. In at least one embodiment, the control unit is configured to monitor temperature and a flow rate of the sanitized water exiting the disinfecting device via at least one temperature sensor and at least one flow meter configured in a conduit connecting the disinfecting device and a thermal distributor. The thermal distributor may be a radiator or a hydronic panel that acts as a heat exchanger to transfer thermal energy for heating or cooling the enclosure. Further, the control unit operates a pump fluidically coupled to the thermal distributor and the disinfecting device for adapting the flow rate of the sanitized water entering the thermal distributor. The flow rate is adapted based at least on a target temperature for conditioning the enclosure, and the temperature and the flow rate associated with the sanitized water, thereby conditioning the enclosure in an efficient manner.

Further, the control unit operates a thermostatic mixing valve that is fluidically coupled to the disinfecting device and the thermal storage tank to adjust the temperature of the sanitized water to a temperature that is safe from scalding. More specifically, the control unit calculates a volume of cold water required for mixing with the sanitized water based at least on the target temperature of the domestic hot water and the temperature of the sanitized water. Thereafter, the control unit operates the valve for blending the sanitized water with the volume of cold water received from an external water supply to deliver the hot water to the domestic hot water at temperatures safe from scalding.

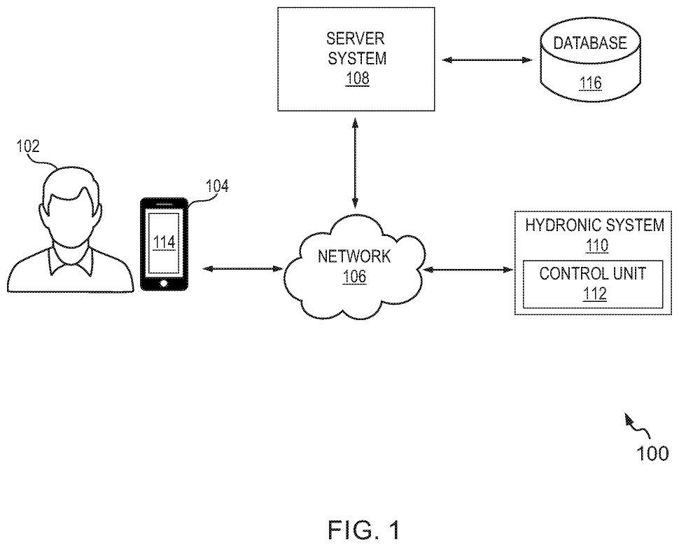

Various embodiments of methods and systems for disinfecting water for hydronic space conditioning systems and domestic hot water delivery are described with reference to FIG. 1 to FIG. 8.

FIG. 1 is an example representation of an environment 100 related to at least some example embodiments of the present disclosure. The environment 100 includes a user 102 interacting with a hydronic system 110 for conditioning an interior of a residential or commercial space. The user 102 may be an individual or an entity associated with a user device 104, for providing user input for operating the hydronic system 110 via a network 106. The network 106 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

The input information from the user 102 may include information such as, but not limited to, temperature requirements associated with a hot water supply and a cold water supply, a temperature associated with space conditioning, and/or any other information required for operation of the hydronic system 110, and information regarding the cost of electricity or the emissions of electricity for example at different times, or other factors. The user 102 may provide input information to the hydronic system 110 using an interactive application (hereinafter referred to as “application 114”) installed on the user device 104. The user device 104 may be any electronic device such as, but not limited to, a personal computer (PC), a tablet device, a Personal Digital Assistant (PDA), a voice activated assistant, wearable devices, a Virtual Reality (VR) device, a smartphone and a laptop.

The environment 100 also includes a server system 108 configured for operating the hydronic system 110. The server system 108 is configured to host and manage the application 114, which is accessible to the user device 104. The application 114 may be accessible through a website associated with the server system 108, so that the user 102 may access the website over the network 106 using web browser applications installed in the user device 104 and thereafter perceive to operate the hydronic system 110. In an embodiment, the server system 108 is configured to facilitate instances of the application 114 to the user device 104, upon receiving a request for accessing the application 114. The server system 108, upon receiving the request, allows instances of the application 114 to be downloaded into the user device 104 for accessing the application 114. In an embodiment, the application 114 may include the Application Programming Interface (API) and other components, which may rest in the server system 108. In this scenario, the application 114 can be made available at application stores, such as Google play store managed by Google®, Apple app store managed by Apple®, etc., and are downloadable from the application stores to be accessed on devices such as the user device 104. In an alternate embodiment, the application 114 may be pre-installed on the user device 104 as per the factory settings. In one configuration, the application 114 is also configured to generate and dynamically update a dashboard (not shown in Figures) by including the input information provided by the user 102. In another configuration, the application 114 is also configured to generate and dynamically update the dashboard by including estimated costs associated with operation of the hydronic system 110 based on the user input.

The environment 100 further includes a database 116 communicably coupled to the server system 108. The database 116 is configured to store information pertaining to the user input provided by the user 102. The database 116 may also be configured to store data pertaining to the temperature requirements of the hot water and the cold water supplies, optimal temperature range for anti-bacterial sanitation, flow rate, storage capacity of the tank, and capacity of disinfecting device, estimated costs, power savings, operating cycles (i.e. on-peak operating cycle or off-peak operating cycle) and the like. The database 116 may be maintained by a third party or embodied within the server system 108.

In one embodiment, the hydronic system 110 includes a control unit 112 that controls operation of the hydronic system 110 based on the user input provided via the application 114. It shall be noted that the control unit 112 can be a standalone component operating apart from the hydronic system 110 for controlling operations of the hydronic system 110. However, in other embodiments, the control unit 112 may actually be incorporated, in whole or in part, into one or more parts of the environment 100, for example, the server system 108. In addition, the control unit 112 should be understood to be embodied in at least one computing device in communication with the network 106, which may be specifically configured, via executable instructions, to perform as described herein, and/or embodied in at least one non-transitory computer readable media.

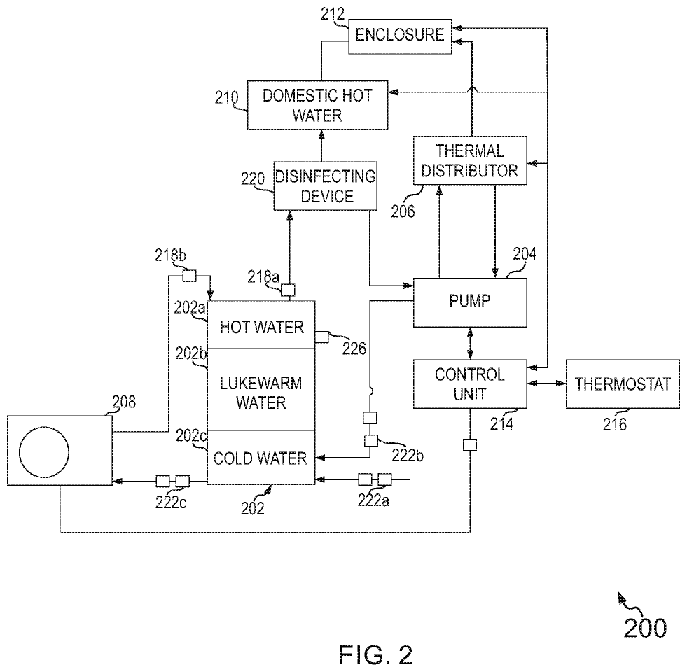

In another embodiment, the control unit 112 may include an interface (not shown in FIGS.) for receiving user inputs. In this scenario, the user 102 may provide input information as discussed above, by using the interface configured on the control unit 112, thus mitigating the use of the user device 104 for providing the input information. In yet another embodiment, the control unit 112 may be operatively coupled with a temperature sensing device that is configured to automatically detect the temperature of indoor space and communicate the information to the control unit 112 which is explained with reference to FIG. 2.

The hydronic system 110 is configured to perform one or more operations described herein. In particular, the control unit 112 is configured to adapt one or more parameters of the hydronic system 110 based on receipt of the input information via at least one of the user device 104, the interface associated with the control unit 112, and the temperature sensing device. In one example, the user 102 may provide the input information pertaining to conditioning of an enclosure (see, 212 of FIG. 2) or requirement of hot water or cold water. The control unit 112 operates the hydronic system 110 based on state of charge (SoC) of the water (i.e. heat transfer medium) within the hydronic system 110 to achieve the required temperature for conditioning the enclosure and the hot water delivery for domestic usage. Specifically, the control unit 112 operates a heat pump unit associated with the hydronic system 110 to either heat or cool the water based on the SoC of the water for conditioning the enclosure.

In addition, the control unit 112 adjusts one or more parameters associated with the hydronic system 110 for disinfecting the water, prior to conditioning the indoor space and the hot water delivery for residential use. To that effect, the control unit 112 is configured to maintain a temperature of the water that is suitable for anti-bacterial sanitation while meeting the space conditioning needs during periods of high heat usage. Further, the control unit 112 is configured to operate the hydronic system 110 to deliver the hot water for domestic usage at the temperature protected from scalding. Specifically, the control unit 112 adapts the one or more parameters (e.g., flow rate, temperature), while ensuring sanitation of the water, to meet the temperature requirements associated with conditioning of the indoor space and the hot water supply. The one or more operations performed by the control unit 112 for operating the hydronic system 110 are further explained in detail.

The number and arrangement of systems, devices, and/or networks shown in FIG. 1 are provided as an example. There may be additional systems, devices, and/or networks, fewer systems, devices, and/or networks, different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

FIG. 2 is a schematic representation of the hydronic system 200, in accordance with some example embodiments of the present disclosure. The hydronic system 200 is an example of the hydronic system 110 as described with reference to FIG. 1. The hydronic system 200 includes a thermal storage tank 202 configured to store water in a stratified manner therein. Particularly, the thermal storage tank 202 may be divided into a compartment 202a (i.e. a top portion) for storing the hot water, a compartment 202b for storing a lukewarm water and a compartment 202c (i.e. a bottom portion) for storing the cold water. The thermal storage tank 202 may be configured with a thermal shielding surface for maintaining the temperature of the water therein. More specifically, the compartments 202a-202c may be formed due to the temperature difference between the hot water, the lukewarm water and the cold water. In other words, the portions 202a to 202c may be formed due to a thermocline layer (referenced as a line within the thermal storage tank 202) formed due to the temperature difference and density associated with the hot water, the lukewarm water, and the cold water.

In one non-limiting example, the hot water may be the water heated to a temperature between 130° F. to 170° F., or any other temperature as per feasibility and requirement. The lukewarm water may be the water at room temperature with a temperature range of about 68° F. to about 80° F., or any other temperature as per feasibility and requirement, and the cold water may be the water cooled to a temperature of 50° F. or any other temperature as per feasibility and requirement.

The thermal storage tank 202 is fluidically coupled to a pump 204. The pump 204 is further fluidically coupled via conduits to a thermal distributor 206 (also referred to as ‘a heat transfer device 206’), a heat pump unit 208, a domestic hot water 210 and the enclosure 212. As such the pump 204 is configured to circulate or route the hot water, the cold water and the lukewarm water suitably within the hydronic system 200. Examples of the pump 204 include, but are not limited to, a positive displacement pump, a peristaltic pump, a centrifugal pump, and the like, as per design feasibility and requirement.

Further, the hydronic system 200 may be configured with a first set of flow meters 222a, 222b and 222c mounted at one or more inlets and outlets of the thermal storage tank 202. In particular, the first set of flow meters 222a-222c is mounted to the bottom portion (i.e. the cold water storage compartment 202c) of the thermal storage tank 202. The first set of flow meters 222a-222c is configured to monitor a volume of cold water entering and exiting the thermal storage tank 202 over time. Alternatively, the flow meters, such as the first set of flow meters 222a-222c may be mounted to the top portion (i.e. the hot water storage compartment 202a) for monitoring a volume of hot water entering and exiting the thermal storage tank 202. Some non-exhaustive examples of the flow meters, such as the first set of flow meters 222a-222c may be one of an optical sensor, a mechanical sensor or any other sensor configured for monitoring the water flow within the conduits entering and exiting the thermal storage tank 202.

The hydronic system 200 further includes a first set of temperature sensors 218a and 218b mounted to the conduit exiting and entering the top portion 202a of the thermal storage tank 202, respectively. The first set of temperature sensors 218a, and 218b is configured to monitor the temperature of the water entering and exiting the top portion 202a of the thermal storage tank 202. In one configuration, the first set of flow meters 222a, 222b and 222c and the first set of temperature sensors 218a and 218b may also be suitably incorporated within the thermal storage tank 202 (not shown in Figures).

Further, the hydronic system 200 includes a first temperature sensor 226 mounted to the thermal storage tank 202. The first temperature sensor 226 is configured to monitor the temperature of the hot water within the thermal storage tank 202. In one configuration, the conduit extending from the top portion 202a of the thermal storage tank 202 for supplying the hot water may be directly connected to the enclosure 212 (not shown in Figures). In one configuration, the conduit extending from the bottom portion 202c for supplying the cold water to the heat transfer device (or thermal distributor) 206 may be directly connected instead to a domestic hot water 210 (not shown in Figures). The thermal distributor 206, on receiving the hot water or the cold water via the pump 204, distributes the heat content to the enclosure 212 for conditioning. Examples of the thermal distributor 206 may include, but are not limited to, a blower, a radiator or hydronic panel configured for distributing the heat content to the enclosure 212. In one implementation, the hydronic system 200 may include a plurality of thermal distributors (e.g., a plurality of radiators) connected in series to provide adequate heating/cooling to the enclosure 212 based on the requirements.

The hydronic system 200 also includes the heat pump unit 208 configured for generating either the hot water or the chilled water. The hot water and/or the chilled water generated in the heat pump unit 208 is routed back to the thermal storage tank 202. In one configuration, the heat pump unit 208 receives cold water from the bottom portion 202c which would be heated for generating the hot water. The generated hot water is routed to the top portion 202a for recharging the hot water within the thermal storage tank 202. In another configuration, the heat pump unit 208 receives lukewarm water from the top portion 202a which would be cooled to generate the chilled water (not shown in Figures). The chilled water may be circulated back to the compartment 202c via conduits connecting the heat pump unit 208 and the compartment 202c (not shown in Figures).

The system 200 also includes a control unit 214 communicably coupled with the thermal storage tank 202 (e.g., as shown in FIG. 2A). The control unit 214 is also communicably coupled to the pump 204, the thermal distributor 206, the domestic hot water 210, the heat pump unit 208 and the enclosure 212. The control unit 214 is an example of the control unit 112 of the hydronic system 110 as described with reference to FIG. 1. The control unit 214 is configured to receive the user input from the user 102, based on which the control unit 214 may operate the hydronic system 200.

Additionally, the hydronic system 200 includes a thermostat 216 (i.e. temperature sensing device) operatively coupled to the control unit 214. The thermostat 216 is configured to sense the temperature of the indoor space (i.e. the enclosure 212) and determine any change in temperature from the required thermal value (as preset by the user 102) or temperature value in the hydronic system 200 suitably, and to provide such data to the control unit 214. In one implementation, the control unit 214 may automatically determine the requirements of the enclosure 212 and accordingly, operate the hydronic system 200 for conditioning the enclosure 212 suitably.

The hydronic system 200 also includes a disinfecting device 220 communicably coupled with the control unit 214, the first set of temperature sensors 218a, and 218b, the pump 204, and the domestic hot water 210. The disinfecting device 220 is configured to sanitize the hot water exiting the thermal storage tank 202, prior to delivery of the water for conditioning the enclosure 212 and the domestic hot water 210. In particular, the disinfecting device 220 is configured to control and/or destroy various bacterial organisms present in the water stored in the thermal storage tank 202 by employing heat. Alternatively, the disinfecting device 220 may employ ultraviolet (UV) radiation, chemicals or any other methods as per feasibility and requirement. This configuration of the hydronic system 200 integrated with the disinfecting device 220 ensures delivery of sanitized water protected from scalding, while meeting the requirements for conditioning the enclosure 212 which is further explained in detail. Some non-exhaustive examples of the disinfecting device 220 may be one of electrical resistance (ER) water heater, ultraviolet (UV) sanitizer, phase change material (PCM) thermal storage and the like.

As explained above, the disinfecting device 220 is configured to heat the water exiting the thermal storage tank 202 for providing anti-bacterial sanitation. In general, the disinfecting device 220 operates (i.e. heats the water) for providing anti-bacterial sanitation based on an outlet temperature of the hot water exiting the thermal storage tank 202. In other words, the disinfecting device 220 is associated with a temperature threshold limit (e.g., 200° F.) for controlling operation of the disinfecting device 220. In an embodiment, the temperature threshold limit may be preset in the disinfecting device 220 and is accessed by the control unit 214 for performing one or more operations which will be explained further in detail. The temperature threshold limit corresponds to a temperature value or a temperature range that ensures anti-bacterial sanitation of the hot water. But for performing anti-bacterial sanitation, the temperature of the hot water entering the disinfecting device 220 must be optimal or should be below the temperature threshold limit.

Further, the control unit 214 is configured to operate the disinfecting device 220 based on receiving input information related to a target temperature associated with conditioning the enclosure 212 and the hot water requirements by the user 102. In this scenario, the hot water from the thermal storage tank 202 is routed to the disinfecting device 220. The control unit 214 is configured to determine the outlet temperature of the hot water exiting the thermal storage tank 202 via the first set of temperature sensors, such as the temperature sensor 218a to operate the disinfecting device 220. The control unit 214 is further configured to calculate a temperature difference between the temperature threshold limit associated with the disinfecting device 220 and the outlet temperature of the hot water. In other words, the control unit 214 compares the temperature sensed by the first set of temperature sensors 218a, and 218b to the temperature threshold limit associated with the disinfecting device 220.

In one scenario, if the outlet temperature of the hot water (i.e. temperature sensed by the temperature sensor 218a) is determined to be less than the temperature threshold limit (i.e. a positive temperature difference value), the control unit 214 transmits a first signal to the disinfecting device 220. The first signal operates the disinfecting device 220 in an activation mode. In the activation mode, the disinfecting device 220 is configured to heat the water at the anti-bacterial temperatures (until the temperature threshold limit) for providing anti-bacterial sanitation. In another scenario, if the outlet temperature of the hot water is determined to be greater and/or equal to the temperature threshold limit (i.e. a negative or zero temperature difference value), the control unit 214 transmits a second signal to the disinfecting device 220. The second signal operates the disinfecting device 220 in a deactivation mode. Further, the second signal is transmitted to the disinfecting device 220 based on completion of the anti-bacterial sanitation process. It should be understood that the temperature difference will be negative or zero value, upon completion of the sanitization process. Thereafter, the sanitized water is selectively routed to the thermal distributor 206 and the domestic hot water 210 based on the requirements.

The control unit 214 receives input information related to the target temperature associated with the conditioning of the enclosure 212. Upon receipt of the input information, the sanitized water is routed to the heat transfer device 206 via the pump 204 for conditioning the enclosure 212. More specifically, the control unit 214 is configured to operate the pump 204 based on the target temperature associated with the enclosure 212 conditioning. In other words, the control unit 214 may adapt the flow rate (either increase or decrease) of the sanitized water routed to the thermal distributor 206 for providing sufficient heating or cooling to the enclosure 212 based on the requirements. Further, the control unit 214 is configured to provide heating or cooling to the enclosure 212 based on detection of a change in the conditioning temperature from a preset value.

Further, the control unit 214 may operate the disinfecting device 220 at a particular temperature within the range of anti-bacterial temperatures for delivering the sanitized water based on the target temperature for conditioning the enclosure 212. For instance, the sanitized water may be heated to about 190° F., and the target temperature for conditioning is 115° F. In this case, operating the pump 204 in lower flow rate may not be sufficient to meet the required target temperature for conditioning the enclosure 212. Thus, the control unit 214 is configured to vary the operating temperature (either increase or decrease) associated with the disinfecting device 220, while ensuring sanitization of the hot water for providing heating or cooling to the enclosure 212 based on the target temperature.

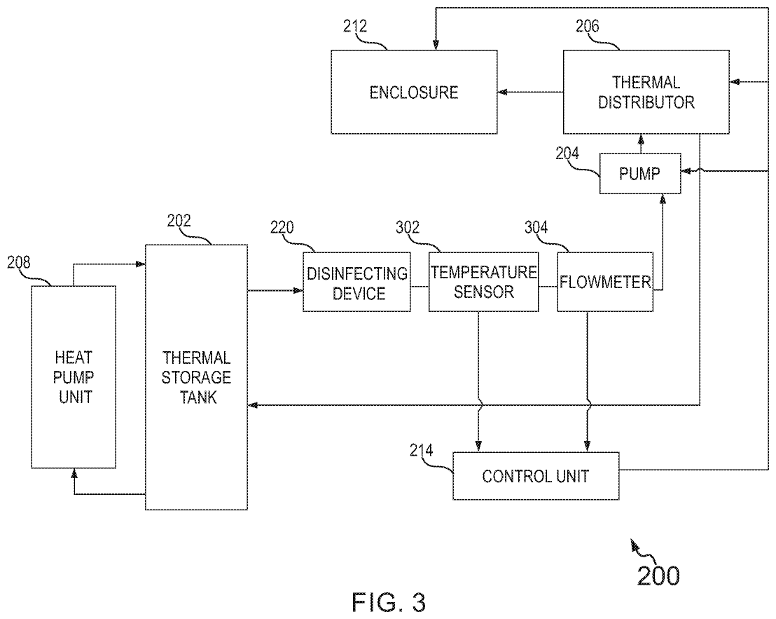

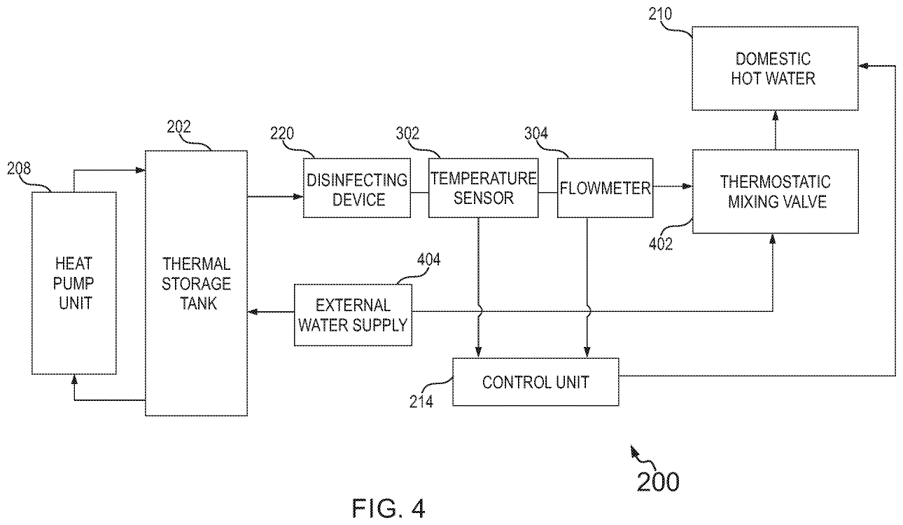

Similarly, the control unit 214 operates the disinfecting device 220 based on the requirements of the hot water by the user 102. More specifically, the disinfecting device 220 is configured to heat the water from the thermal storage tank 202 based on the target temperature of the hot water required by the user 102, while ensuring sanitization and safety against scalding at a point of use. In an example scenario, the temperature of the sanitized water delivered to the domestic hot water 210 may be high enough to pose a scalding risk at the point of use. It should be noted that the temperature and the flow rate of the sanitized water should be determined for delivering the sanitized water at temperatures protected from scalding and for providing appropriate heating or cooling to the enclosure 212. To that effect, the hydronic system, such as the hydronic system 200 may be configured with at least one temperature sensor and at least one flow meter at the outlet of the disinfecting device 220 for improving the efficacy of the system 200 which is further explained with reference to FIGS. 3 and 4.

In some embodiments, the hydronic system 200 may include control algorithms that are capable of predicting the preferred usage and avoidance of the disinfecting device 220 based on one or more factors such as, but are not limited to, operating cost of the disinfecting device 220, greenhouse gas reduction, on-peak, and off-peak operation cycles and utility-provider signaling. As an example, the time period between 6 AM to 9 AM and 6 PM to 9 PM of a day, where the user 102 is engaged in daily activities, may be considered as the on-peak operation cycle. In another implementation, the on-peak operation cycle may be the time at which the cost of energy (i.e. electricity) is the highest. The off-peak operation cycle may be the remainder time period of the day or may be the time at which the cost of energy is low. Operating the disinfecting device 220 based on the operating cycles and the utility-provider signaling is further explained in detail.

FIG. 3 is a simplified block diagram representation of the hydronic system 200 for improving efficacy in conditioning the enclosure 212, in accordance with an embodiment of the present disclosure. As shown in FIG. 3, the conduit connecting the disinfecting device 220 to the thermal distributor 206 via the pump 204 is configured with at least one temperature sensor 302, and at least one flow meter 304. In this configuration, the temperature sensor 302 and the flow meter 304 are configured to detect the temperature and the flow rate associated with the sanitized water from the disinfecting device 220 respectively. The control unit 214 with access to data from the temperature sensor 302 and the flow meter 304, is configured to modulate (increase or decrease) the flow rate in the pump 204 for adjusting the flow of water entering the thermal distributor 206, thereby providing appropriate heating or cooling to the enclosure 212. For instance, the temperature and flow rate of the sanitized water entering the thermal distributor 206 are 185° F. and low respectively, and the target temperature may be 130° F. In this scenario, the control unit 214 increases the flow rate in the pump 204. This enables the thermal distributor 206 to extract sufficient heat from the sanitized water corresponding to the target temperature (e.g., 130° F.) for conditioning the enclosure 212. It should be noted that the flow rate is inversely proportional to the amount of heat extracted from the sanitized water by the thermal distributor 206. Knowledge of the temperature and the flow rate measurements of the sanitized water helps in conditioning of the enclosure 212 in an efficient manner, thus improving the optimal efficacy of the hydronic system 200.

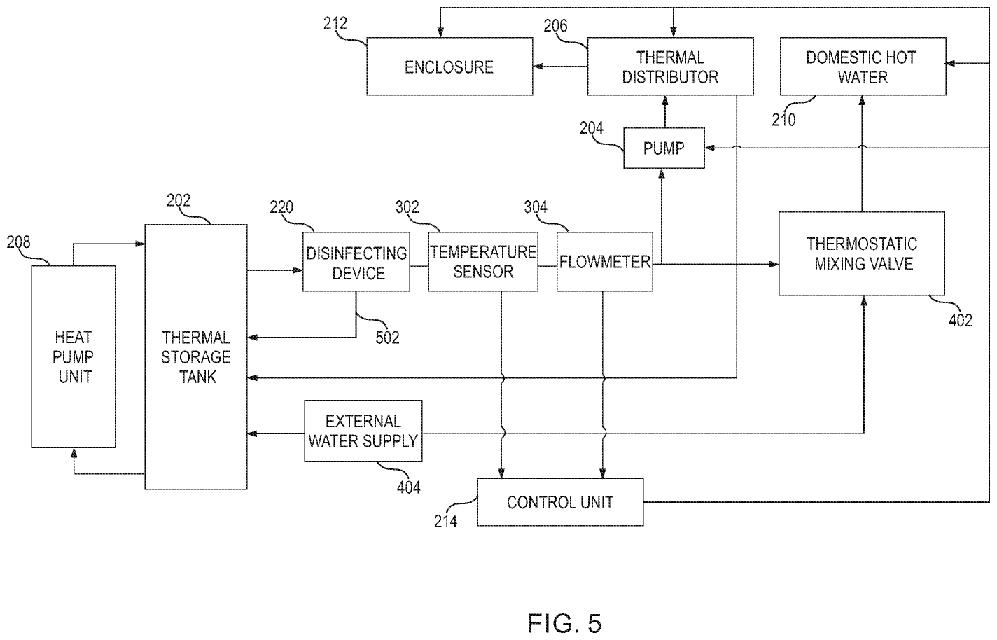

In one implementation, the control unit 214 may receive the input information related to a new target temperature or detect a change in temperature in the enclosure 212, while either conditioning the enclosure 212 or delivery of hot water at the previous target temperature. In other words, the control unit 214 may detect load shifting in the hydronic system 200. In this scenario, a volume of the sanitized water heated to the previous target temperature is routed back to the thermal storage tank 202 for storage via a return path (see, 502 of FIG. 5). This provides an alternative operating mode for the thermal storage system (i.e. the hydronic system 200). The control unit 214 may operate the disinfecting device 220 to adapt the temperature of the hot water (i.e. the sanitized water routed back to the tank 202) to the new target temperature for the enclosure 212 conditioning or the hot water delivery to the domestic hot water 210.

In another implementation, the control unit 214 may perform the aforementioned operations based at least on the receipt of the input information regarding availability of very low cost electricity, or alternatively high usage signals from the electric utility service provider. More specifically, the server system 108 may communicate the aforementioned input information (i.e. on-peak, and off-peak operation cycles and utility-provider signaling) received from the electricity service provider to the control unit 214. The control unit 214 may operate the disinfecting device 220 to heat the water (i.e. sanitization) during off-peak operating cycle (or when the cost of electricity is low). Further, the control unit 214 may provide a signal to the disinfecting device 220 to route the heated water back to the tank 202 for storage and future use or during on-peak operating cycle. Furthermore, the control unit 214 may selectively operate the disinfecting device 220 and the heat pump unit 208 based on utility-provider signaling. In one scenario, the control unit 214 operates the disinfecting device 220 (or low power resistance heater) to heat the water when the grid is requiring low electricity use. Additionally, the aforementioned operations are performed by the control unit 214 based on receipt of information related to parameters such as greenhouse gas emission signals or any other input signals related to operating conditions of the hydronic systems (i.e. the hydronic system 200).

In yet another implementation, the sanitized water may be routed back to the tank 202, based on the capacity and/or the flow rate associated with the disinfecting device 220. For example, if the capacity and/or the flow rate of the disinfecting device 220 is determined to be low, then the sanitized water may be routed back to the tank 202 for storage. This configuration of the hydronic system 200 including the return path 502 for routing back the sanitized water during various conditions as explained above will mitigate the wastage of energy (heat content associated with the sanitized water), reduces the operating time of the disinfecting device 220 during load shifting conditions, operating costs and the like.

FIG. 4 is a simplified block diagram representation of the hydronic system 200 for improving the efficacy of hot water delivery to the domestic hot water 210, in accordance with an embodiment of the present disclosure. As shown in FIG. 4, the conduit connecting the disinfecting device 220 and the domestic hot water 210 includes the temperature sensor 302 and the flow meter 304. Further, the hydronic system 200 includes a thermostatic mixing valve 402 fluidically coupled to the disinfecting device 220, an external water supply 404 and the domestic hot water 210. The external water supply 404 may be municipality water supply systems, water utilities and the like. As such, the hydronic system 200 is configured to receive water from the external water supply 404 (e.g., as shown in FIG. 4) for performing one or more operations as discussed above. The temperature range of water from the external water supply 404 may be less than or equal to 50° F. (cold water), or any other temperature dependent on the external water supply 404 that is sufficient for cooling the hot water from the disinfecting device 220.

The thermostatic mixing valve 402 is configured to ensure delivery of the water to the domestic hot water 210 at safe temperatures. In other words, the thermostatic mixing valve 402 is a valve that adapts temperature of the hot water that is safe from scalding. Upon receiving the input information related to the target temperature of the hot water, the disinfecting device 220 is operated to generate the sanitized water (hot water), as explained with reference to FIG. 2. Further, the control unit 214 is configured to operate the thermostatic mixing valve 402 based on the temperature measurements from the temperature sensor 302. The control unit 214 further determines a volume of cold water required for blending with the sanitized water based on the temperature of the sanitized water.

Thereafter, the thermostatic mixing valve 402 receives the cold water from the external water supply 404 and the sanitized water from the disinfecting device 220. The thermostatic mixing valve 402 blends the sanitized water with the cold water for delivering the hot water to the domestic hot water 210 at the temperature protected from scalding. In other words, the thermostatic mixing valve 402 adapts the temperature of the sanitized water to a temperature that is below the temperature threshold limit, while ensuring protection against scalding at the point of use. In one implementation, the volume of cold water to be blended with the sanitized water for meeting the requirements is determined based at least on the target temperature of the hot water delivery.

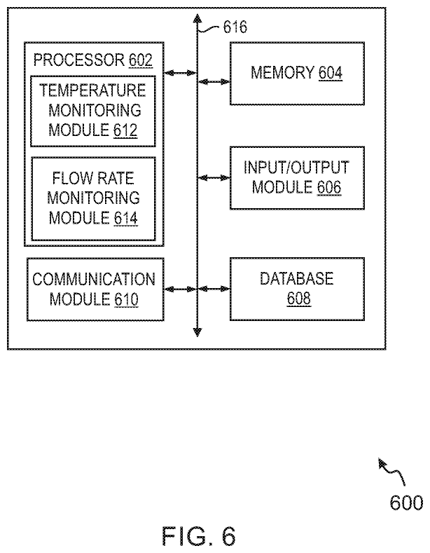

FIG. 6 is a block diagram representation 600 of the control unit 214 (shown in FIG. 2) configured for operating the hydronic system 200, in accordance with an example embodiment of the present disclosure. The control unit 214 includes various processing modules for operating the hydronic system 200. The processing modules described herein may be implemented by a combination of hardware, software and firmware components.

The control unit 214 includes a processor 602, a memory 604, an input/output module 606 (hereinafter referred to as “I/O module 606”), and a database 608. The processor 602 includes a temperature monitoring module 612 and a flow rate monitoring module 614. It is noted that although the control unit 214 is depicted to include only one processor 602, the control unit 214 may include more number of processors therein. Moreover, it shall be noted that the components are shown for exemplary purposes and the control unit 214 may include fewer or additional modules than those depicted in FIG. 6.

In an embodiment, the memory 604 is capable of storing machine-executable instructions. Further, the processor 602 is capable of executing the machine-executable instructions to perform the functions described herein. More specifically, the instructions stored in the memory 604 are used by the processor 602 for conditioning the enclosure 212 and delivery of the hot water to the domestic hot water 210 at the temperatures safe from scalding which will be explained in further detail later. The processor 602 embodies or is in communication with the components, such as the temperature monitoring module 612 and the flow rate monitoring module 614. In an embodiment, the processor 602 may be embodied as a multi-core processor, a single-core processor, or a combination of one or more multi-core processors and one or more single-core processors. For example, the processor 602 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application-specific integrated circuit (ASIC), a field-programmable gate array (FPGA), a microcontroller unit (MCU), a hardware accelerator, a special-purpose computer chip, or the like. In an embodiment, the processor 602 may be configured to execute hard-coded functionality. In an embodiment, the processor 602 is embodied as an executor of software instructions, wherein the instructions may specifically configure the processor 602 to perform the algorithms and/or operations described herein when the instructions are executed.

The memory 604 may be embodied as one or more volatile memory devices, one or more non-volatile memory devices, and/or a combination of one or more volatile memory devices and non-volatile memory devices. For example, the memory 604 may be embodied as semiconductor memories (such as mask ROM, PROM (programmable ROM), EPROM (erasable PROM), flash memory, RAM (random access memory), etc.), magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc) and BD (BLU-RAY® Disc).

In an embodiment, the I/O module 606 may include mechanisms configured to receive the input information from the user 102 for operating the hydronic system 200 and also provide output to the user 102 via the application 114. For example, the I/O module 606 is configured to receive the user inputs from the user 102 related to temperature requirements (such as target temperature for conditioning the enclosure 212 and the hot water), time settings, price of electricity (at different times such as, off-peak operating cycle and on-peak operating cycle), emissions due to electricity (for example at different times), etc. To that effect, the input/output module 606 may include at least one interface and/or at least one output interface.

Additionally, the control unit 214 includes the database 608 configured for storing information pertaining to the input information provided by the user 102. The database 608 may also be configured to store information exchanged or generated during each step of the analysis by the processor 602, for operating the hydronic system 200. The database 608 may be encrypted suitably for ensuring the security of the stored information. The database 608 may also be configured to maintain log of the data processed by each of the modules (such as the temperature monitoring module 612 and the flow rate monitoring module 614) within the processor 602. The log allows the user 102 to track and understand the analysis performed by the processor 602.

The various modules of the control unit 214, such as the processor 602, the memory 604, the I/O module 606, the database 608, the temperature monitoring module 612 and the flow rate monitoring module 614 may be configured to communicate with each other through a centralized circuit system 616. The centralized circuit system 616 may be various devices configured to, among other things, provide or enable communication between the components (602 to 614) of the control unit 214. In certain embodiments, the centralized circuit system 616 may be software-based, a central printed circuit board (PCB) such as a motherboard, a main board, a system board, or a logic board. The centralized circuit system 616 may also, or alternatively, include other printed circuit assemblies (PCAs) or communication channel media.

In an embodiment, the temperature monitoring module 612 may be configured to monitor the temperatures associated with the hot water and the cold water entering or exiting the tank 202. The module 612 may monitor the operating temperatures of the hot water and the cold water, based on the temperature measured by the first set of temperature sensors 218a, and 218b. Additionally, the module 612 is communicably coupled to the first temperature sensor 226 for monitoring the temperature or SoC of the water within the tank 202. This configuration enables to ascertain the temperature thermal losses associated with the ambient temperature while the water is in the tank 202, and during flow of the hot water in the conduits. This allows the hydronic system 200 to compensate for the thermal losses by operating the heat pump unit 208 for maintaining the water within the tank 202 at the predefined threshold valve. In one implementation, the module 612 may determine the operating temperatures of the hot water and the cold water, based on the climatic conditions or the operation cycle of the system 200. Further, the module 612 may be configured to monitor the operating temperatures of the disinfecting device 220 based on the outlet temperature of the hot water from the tank 202. In addition, the module 612 may be configured to monitor the temperature of the sanitized water exiting the disinfecting device 220 via the temperature sensor 302.

In one embodiment, the flow rate monitoring module 614 may be configured to monitor the flow rate associated with the water from the tank 202 via the first set of flow meters 222a-222c. The module 614 may be further configured to monitor the flow rate of the sanitized water from the disinfecting device 220 via the flow meter 304. In some embodiments, a communication module 610 may receive sensor data (e.g., temperature measurements and flow rates) from other systems configured to measure temperature/flow rate in real-time or from a database that stores near real-time information as recorded by other devices/systems coupled to the hydronic system 200. The sensor data are continuously monitored for determining optimal parameters so as to provide the sanitized water for optimal conditioning of the enclosure 212 and for residential use at temperatures safe from scalding. In particular, the processor 602 in conjunction with the instructions stored in the memory 604 may be configured to process the sensor data and adapt one or more parameters (e.g., operating temperatures, flow rate, etc.,) of the components in the hydronic system 200 to deliver the water safe for scalding risk, provide anti-bacterial sanitation and meet space (the enclosure 212) conditioning needs in the hydronic system 200.

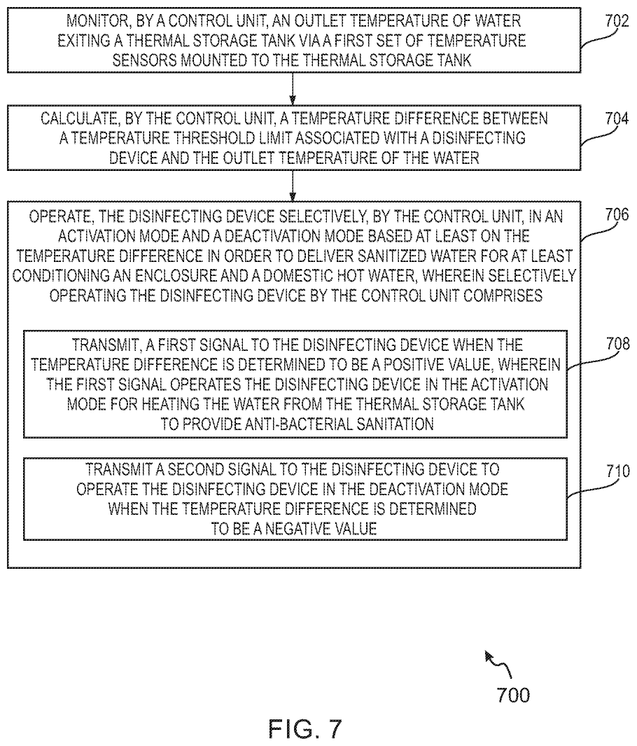

FIG. 7 illustrates a flow diagram of a method 700 for disinfecting water for hydronic space conditioning and domestic hot water delivery, in accordance with an example embodiment of the present disclosure. The various steps and/or operations of the flow diagram, and combinations of steps/operations in the flow diagram, may be implemented by, for example, hardware, firmware, a processor, circuitry and/or by an apparatus such as the control unit 214 explained with reference to FIGS. 2 to 5 and/or by a different device associated with the execution of software that includes one or more computer program instructions. The method 700 starts at 702.

At operation 702, the method 700 includes monitoring, by a control unit, an outlet temperature of the water exiting the thermal storage tank via a first set of temperature sensors mounted to the thermal storage tank. The outlet temperature of the hot water exiting the thermal storage tank enables the disinfecting device to operate for providing anti-bacterial sanitation. Further, the control unit is configured to monitor the SoC of the water in the thermal storage tank for maintaining the temperature of the hot water within an optimal range which is suitable for anti-bacterial sanitation. In other words, the heat pump unit is operated by the control unit for generating the hot water for recharging a volume of hot water within the thermal storage tank, when the temperature of the hot water within the thermal storage tank falls below a predefined threshold value. The predefined threshold value corresponds to a temperature that is optimal for operating the disinfecting device between the activation mode and the deactivation mode.

At operation 704, the method 700 includes calculating, by the control unit, a temperature difference between a temperature threshold limit associated with a disinfecting device and the outlet temperature of the water. In other words, the control unit may be configured to compare the outlet temperature of the water exiting the thermal storage tank with the temperature threshold limit associated with the disinfecting device.

At operation 706, the method 700 includes operating the disinfecting device selectively, by the control unit, in an activation mode and a deactivation mode based at least on the temperature difference in order to deliver sanitized water for at least conditioning an enclosure and a domestic hot water. At 708, the method 700 includes transmitting a first signal to the disinfecting device when the temperature difference is determined to be a positive value. The first signal operates the disinfecting device in the activation mode for heating the water from the thermal storage tank for providing anti-bacterial sanitation. The disinfecting device may heat the water from the thermal storage tank until the temperature of the water reaches the temperature threshold limit (or at anti-bacterial temperatures) for providing anti-bacterial sanitation. At 710, the method 700 includes transmitting a second signal to the disinfecting device to operate the disinfecting device in the deactivation mode when the temperature difference is determined to be a negative value. Further, the second signal may be transmitted to the disinfecting device when the temperature of the hot water in the disinfecting device reaches or exceeds the temperature threshold limit. The operations 702 to 710, for disinfecting the water from the thermal storage tank 202 for hydronic space conditioning and domestic hot water delivery by the control unit 214 are already described in detail in description pertaining to FIGS. 2-5, and it is not reiterated herein for the sake of brevity.

Additionally, the control unit is configured to monitor a temperature and a flow rate of the sanitized water exiting the disinfecting device via at least one temperature sensor and at least one flow meter configured in a conduit connecting the disinfecting device and a thermal distributor. Further, the control unit operates a pump for adapting the flow rate of the sanitized water entering a thermal distributor. The pump adjusts the flow rate based at least on a target temperature for conditioning the enclosure, and the temperature and the flow rate associated with the sanitized water. Furthermore, the control unit is configured to calculate a volume of cold water required for mixing with the sanitized water based at least on the target temperature of the hot water and the temperature of the sanitized water. Thereafter, the control unit operates a thermostatic mixing valve for blending the sanitized water with the volume cold water received from an external water supply to reduce the temperature of the sanitized water below the temperature threshold limit for delivering the sanitized water to the domestic hot water at the temperature protected from scalding.

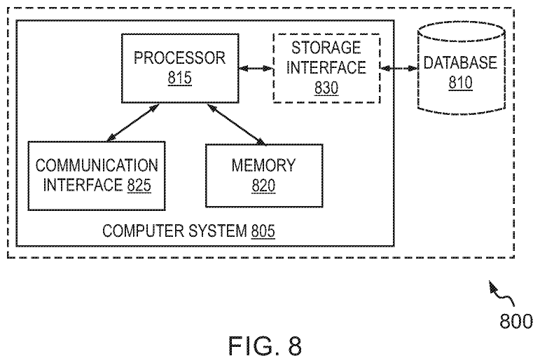

FIG. 8 illustrates a block diagram representation of a server system 800 capable of implementing at least some embodiments of the present disclosure. The server system 800 is configured to host and manage the application 114 that is provided to an electronic device such as the user device 104. An example of the server system 800 is the server system 108 shown and described with reference to FIG. 1. The server system 800 includes a computer system 805 and a database 810.

The computer system 805 includes at least one processor 815 for executing instructions. Instructions may be stored in, for example, but not limited to, a memory 820. The processor 815 may include one or more processing units (e.g., in a multi-core configuration).

The memory 820 is a storage device embodied as one or more volatile memory devices, one or more non-volatile memory devices, and/or a combination of one or more volatile memory devices and non-volatile memory devices, for storing micro-contents information and instructions. The memory 820 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The processor 815 is operatively coupled to a communication interface 825 such that the computer system 805 is capable of communicating with a mobile device, for example, the user device 104 or communicates with any entity within the network 106 via the communication interface 825.

The processor 815 may also be operatively coupled to the database 810. The database 810 is any computer-operated hardware suitable for storing and/or retrieving data, such as, but not limited to, the user input, the temperature data, the load data, data obtained during operation of the system 200 and the like. The database 810 may include multiple storage units such as hard disks and/or solid-state disks in a redundant array of inexpensive disks (RAID) configuration. The database 810 may include a storage area network (SAN) and/or a network attached storage (NAS) system.

In some embodiments, the database 810 is integrated within the computer system 805. For example, the computer system 805 may include one or more hard disk drives as the database 810. In other embodiments, the database 810 is external to the computer system 805 and may be accessed by the computer system 805 using a storage interface 830. The storage interface 830 is any component capable of providing the processor 815 with access to the database 810. The storage interface 830 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 815 with access to the database 810.

The processor 815 is communicably coupled with the memory 820 and the communication interface 825. The processor 815 is capable of executing the stored machine-executable instructions in the memory 820 or within the processor 815 or any storage location accessible to the processor 815. The processor 815 may be embodied in a number of different ways. In an example embodiment, the processor 815 may be embodied as one or more of various processing devices, such as a coprocessor, a microprocessor, a controller, a digital signal processor (DSP), processing circuitry with or without an accompanying DSP, or various other processing devices including integrated circuits such as, for example, an application-specific integrated circuit (ASIC), a field-programmable gate array (FPGA), a microcontroller unit (MCU), a hardware accelerator, a special-purpose computer chip, or the like. The processor 815 performs various functionalities of the server system 800 as described herein.

The disclosed one or more operations of the flow diagrams 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), mobile communications, or other such communication means.

Various embodiments disclosed herein provide numerous advantages. More specifically, the embodiments disclosed herein provide methods for disinfecting water in hydronic space conditioning systems. The control unit adapts parameters so as to deliver hot water for residential use at temperatures safe from scalding, and to provide anti-bacterial sanitation while meeting space conditioning requirements. Moreover, the control circuit ensures nominal performance levels of the hydronic system by establishing a balance of water flow and heat delivery for typical conditions. Such adaptation of the parameters of the hydronic system ensures efficient performance and fuel usage thereby reducing the operating costs associated with the hydronic system.

Various embodiments of the disclosure, is as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system, comprising:
a thermal storage tank;
a disinfecting device operatively coupled to the thermal storage tank; and
a control unit operatively coupled to the disinfecting device, the control unit configured to at least:
monitor an outlet temperature of water exiting the thermal storage tank via a first set of temperature sensors mounted to the thermal storage tank,
calculate a temperature difference between a temperature threshold limit associated with the disinfecting device and the outlet temperature of the water exiting the thermal storage tank, and
operate the disinfecting device selectively, in an activation mode and a deactivation mode based at least on the temperature difference in order to deliver sanitized water for at least one of: conditioning an enclosure; and a domestic hot water,
wherein, a first signal is transmitted to the disinfecting device when the temperature difference is determined to be a positive value, wherein the first signal operates the disinfecting device in the activation mode for heating the water from the thermal storage tank to provide anti-bacterial sanitation, and
wherein a second signal is transmitted to the disinfecting device to operate the disinfecting device in the deactivation mode when the temperature difference is determined to be a negative value.

2. The system as claimed in claim 1, wherein the control unit is further configured to:
monitor a temperature of the sanitized water exiting the disinfecting device via at least one temperature sensor configured in a conduit connecting the disinfecting device and a thermal distributor; and
monitor a flow rate of the sanitized water exiting the disinfecting device via at least one flow meter configured in the conduit connecting the disinfecting device and the thermal distributor.

3. The system as claimed in claim 2, wherein the control unit is further configured to:
operate a pump fluidically coupled to the thermal distributor and the disinfecting device for adjusting the flow rate of the sanitized water entering the thermal distributor, wherein the flow rate is adjusted based at least on a target temperature for conditioning the enclosure, and the temperature and the flow rate of the sanitized water exiting the disinfecting device.

4. The system as claimed in claim 2, further comprising:
a thermostatic mixing valve fluidically coupled to the disinfecting device and the thermal storage tank, wherein the thermostatic mixing valve is configured to adjust the temperature of the sanitized water below the temperature threshold limit for delivering the sanitized water to the domestic hot water at the temperature protected from scalding.

5. The system as claimed in claim 4, wherein the temperature of the sanitized water delivered to the domestic hot water is adjusted by mixing the sanitized water from the disinfecting device with a volume of cold water from an external water supply that is fluidically coupled to the domestic hot water and the thermal storage tank, wherein the volume of cold water is received based at least on:
the temperature of the sanitized water, and
a target temperature associated with the domestic hot water.

6. The system as claimed in claim 1, wherein the control unit is configured to operate the disinfecting device for transferring a volume of the sanitized water to the thermal storage tank for storage, wherein the sanitized water is routed back to the thermal storage tank based at least on:
determining a new target temperature for conditioning the enclosure, while conditioning the enclosure with the sanitized water that is heated to a previous target temperature.

7. The system as claimed in claim 1, wherein the control unit is further configured to:
receive input information related to operating cycles from the electric utility service provider via a server system communicably coupled to the control unit;
operate the disinfecting device selectively to heat the water from the thermal storage tank when the operating cycle is in off-peak operating cycle; and
route the heated water from the disinfecting device to the thermal storage tank for storage.

8. The system as claimed in claim 1, wherein the disinfecting device is at least one of:
an electrical resistance (ER) water heater;
an ultraviolet (UV) sanitizer; and
a phase change material (PCM) thermal storage.

9. A method for disinfecting water for hydronic space conditioning and domestic hot water delivery, the method comprising:
monitoring, by a control unit, an outlet temperature of water exiting a thermal storage tank via a first set of temperature sensors mounted to the thermal storage tank;
calculating, by the control unit, a temperature difference between a temperature threshold limit associated with a disinfecting device and the outlet temperature of the water; and
operating the disinfecting device selectively, by the control unit, in an activation mode and a deactivation mode based at least on the temperature difference in order to deliver sanitized water for at least conditioning an enclosure and a domestic hot water, wherein selectively operating the disinfecting device by the control unit comprises:
transmitting a first signal to the disinfecting device when the temperature difference is determined to be a positive value, wherein the first signal operates the disinfecting device in the activation mode for heating the water from the thermal storage tank to provide anti-bacterial sanitation, and
transmitting a second signal to the disinfecting device to operate the disinfecting device in the deactivation mode when the temperature difference is determined to be a negative value.

10. The method as claimed in claim 9, further comprising:
monitoring, by the control unit, a temperature of the sanitized water exiting the disinfecting device via at least one temperature sensor configured in a conduit connecting the disinfecting device and a thermal distributor; and
monitoring, by the control unit, a flow rate of the sanitized water exiting the disinfecting device via at least one flow meter configured in the conduit connecting the disinfecting device and the thermal distributor.

11. The method as claimed in claim 10, further comprising:
operating, by the control unit, a pump for adapting the flow rate of the sanitized water entering the thermal distributor, wherein the flow rate is adjusted based at least on a target temperature for conditioning the enclosure, and the temperature and the flow rate of the sanitized water exiting the disinfecting device.

12. The method as claimed in claim 10, further comprising:
operating, by the control unit, a thermostatic mixing valve fluidically coupled to the disinfecting device and the thermal storage tank to adapt the temperature of the sanitized water below the temperature threshold limit for delivering the sanitized water to the domestic hot water at the temperature protected from scalding.

13. The method as claimed in claim 12, wherein adapting the temperature of the sanitized water further comprises:
calculating, by the control unit, a volume of cold water required for mixing with the sanitized water based at least on a target temperature of the domestic hot water and the temperature of the sanitized water; and
operating, by the control unit, the thermostatic mixing valve for blending the sanitized water with the volume of cold water received from an external water supply to reduce the temperature of the sanitized water below the temperature threshold limit.

14. The method as claimed in claim 9, further comprising:
determining, by the control unit, a new target temperature for conditioning the enclosure, while conditioning the enclosure with the sanitized water that is heated to the previous target temperature; and
operating, by the control unit, the disinfecting device to transfer a volume of the sanitized water to the thermal storage tank for storage.

15. The method as claimed in claim 9, further comprising:
receiving, by the control unit, input information related to operating cycles from the electric utility service provider via a server system communicably coupled to the control unit;
operating the disinfecting device selectively, by the control unit, to heat the water from the thermal storage tank when the operating cycle is in off-peak operating cycle; and
operating, by the control unit, the disinfecting device to route the heated water to the thermal storage tank for storage.

16. A system for disinfecting water for hydronic space conditioning and domestic hot water delivery, the system comprising:
a thermal storage tank;
a disinfecting device operatively coupled to the thermal storage tank; and
a control unit operatively coupled to the disinfecting device, the control unit configured to at least:
monitor an outlet temperature of water exiting the thermal storage tank via a first set of temperature sensors mounted to the thermal storage tank,
calculate a temperature difference between a temperature threshold associated with the disinfecting device and the outlet temperature of the water exiting the thermal storage tank,
operate the disinfecting device selectively, in an activation mode and a deactivation mode based at least on the temperature difference in order to deliver sanitized water for at least one of: conditioning an enclosure; and a domestic hot water, wherein,
a first signal is transmitted to the disinfecting device when the temperature difference is determined to be a positive value, wherein the first signal operates the disinfecting device in the activation mode for heating the water from the thermal storage tank to provide anti-bacterial sanitation, and
a second signal is transmitted to the disinfecting device to operate the disinfecting device in the deactivation mode when the temperature difference is determined to be a negative value,
monitor a temperature of the sanitized water exiting the disinfecting device via at least one temperature sensor configured in a conduit connecting the disinfecting device and a thermal distributor,
monitor a flow rate of the sanitized water exiting the disinfecting device via at least one flow meter configured in the conduit connecting the disinfecting device and the thermal distributor, and
operate a pump fluidically coupled to the thermal distributor and the disinfecting device for adjusting the flow rate of the sanitized water entering the thermal distributor, wherein the flow rate is adjusted based at least on a target temperature for conditioning the enclosure, and the temperature and the flow rate of the sanitized water exiting the disinfecting device.

17. The system as claimed in claim 16, further comprising:
a thermostatic mixing valve fluidically coupled to the disinfecting device and the thermal storage tank, wherein the thermostatic mixing valve is configured to adjust the temperature of the sanitized water below the temperature threshold limit for delivering the sanitized water to the domestic hot water at the temperature protected from scalding.

18. The system as claimed in claim 17, wherein the temperature of the sanitized water delivered to the domestic hot water is adjusted by mixing the sanitized water from the disinfecting device with a volume of cold water from an external water supply that is fluidically coupled to the domestic hot water and the thermal storage tank, wherein the volume of cold water is received based at least on:
the temperature of the sanitized water, and
a target temperature of the hot water associated with the domestic hot water.

19. The system as claimed in claim 16, wherein the control unit is configured to operate the disinfecting device for transferring a volume of the sanitized water to the thermal storage tank for storage, wherein the sanitized water is routed back to the thermal storage tank based at least on:
determining a new target temperature for conditioning the enclosure, while conditioning the enclosure with the sanitized water that is heated to a previous target temperature.

20. The system as claimed in claim 16, wherein the control unit is further configured to:
receive input information related to operating cycles from the electric utility service provider via a server system communicably coupled to the control unit;
operate the disinfecting device selectively to heat the water from the thermal storage tank when the operating cycle is in off-peak operating cycle; and
route the heated water from the disinfecting device to the thermal storage tank for storage.
